(19) United States
(12) Patent Application Publication
(10) Pub. No.: US 2026/0160046 A1
(43) Pub. Date: Jun. 11, 2026

(54) MULTI-MACHINE PAYLOAD SYSTEM FOR REAL-TIME TOTAL LOAD MONITORING ACROSS CONSTRUCTION EQUIPMENT

(71) Applicant: Caterpillar Paving Products Inc., Brooklyn Park, MN (US)

(72) Inventors: Nathaniel S. Doy, Clayton, NC (US); Matthew T. Hanson, St. Louis Park, MN (US); Jacob J. McAlpine, Otsego, MN (US)

(21) Appl. No.: 18/974,532

(22) Filed: Dec. 9, 2024

(51) Int. Cl. E02F 9/24; E02F 9/26; G01G 19/02; G06Q 10/08; G06Q 50/08

(52) U.S. Cl. CPC E02F 9/24; E02F 9/26; G01G 19/02; G06Q 10/08; G06Q 50/08

(57) ABSTRACT

A multi-machine payload system integrates payload measurements from construction equipment to provide total payload estimates when loading trucks. The system combines real-time payload data from cold planers having conveyor-based measurement systems and support machines such as wheel loaders using GPS and wireless communication to determine machine-truck associations. For cold planers, the system measures material transfer using force transducers and hydraulic pressure sensors, while wheel loaders employ boom angles and cylinder pressures to determine loads. The system processes the combined payload data to track total accumulated weight, comparing it against truck weight limits and generating alerts as limits are approached. The system can be implemented using individual machine controllers, machine-to-machine communication, or servers.

### TECHNICAL FIELD

The present disclosure relates to payload monitoring systems for construction equipment, particularly systems that combine real-time payload measurements from multiple machines during material loading operations.

### BACKGROUND

Construction equipment such as cold planers, wheel loaders, and excavators are used in road construction and maintenance operations. Cold planers, also known as road mills or scarifiers, use rotating milling drums to remove layers of asphalt surfaces, with the milled material being transferred via conveyor systems into transport vehicles. These machines can use various measurement systems incorporating load cells, pressure sensors, and speed monitoring devices to track material movement during operations. Modern construction equipment can feature monitoring systems that can measure operational parameters such as conveyor belt speeds, hydraulic pressures, and material weights using combinations of mechanical and electronic sensors. Transport vehicles such as haul trucks are used to move milled material away from work sites, with their operation governed by various weight restrictions and efficiency considerations.

U.S. Pat. No. 10,539,451 discloses a yield measurement system for a cold planer that uses a hydraulic motor to drive a conveyor, however, the patent does not describe the integration of payload data from multiple machines loading the same truck. There is therefore a need for methods that can combine real-time payload measurements from both cold planers and support machines such as wheel loaders to provide total accumulated weight monitoring.

### SUMMARY

This document discloses methods, systems, and apparatuses for monitoring and managing payload measurements across multiple construction machines during material loading operations. More specifically, the disclosure pertains to payload measurement systems that integrate data from cold planers having conveyor-based measurement systems and support machines such as wheel loaders, excavators, compact track loaders, and skid steers, to provide real-time total payload estimates when loading material into transport vehicles. The systems and methods enable accurate tracking of cumulative payload amounts from multiple loading sources while preventing overloading of transport vehicles beyond weight limits.

In some implementations, a payload monitoring system receives first payload data from a cold planer's measurement system and second payload data from a support machine's measurement system regarding material being loaded into a transport vehicle. Machine identities are determined using manual operator input, global positioning system (GPS) location data, and/or proximity detection. The payload data is combined to determine total accumulated weight in real-time. The total weight is compared to a predetermined weight limit. Alerts are generated when approaching the weight limit. The total accumulated weight, remaining capacity for the transport vehicle, machine identities, and/or alerts can be sent to a computer device. The system enables tracking of cumulative payload from multiple loading sources while preventing transport vehicle overloading beyond weight limits. The support machine may include wheel loaders, excavators, compact track loaders or skid steers working alongside the cold planer.

In some implementations, a computer system determines that a cold planer machine is estimating material weight being loaded into a transport vehicle and that a support machine (e.g., an earthmover or wheel loader) is also loading material into the same transport vehicle. Payload information from both measurement systems is combined to determine total accumulated weight in real-time. Machine identities are determined using GPS data, short range wireless communication, and/or cellular networks. Alerts are generated when total accumulated weight approaches a predetermined weight limit to prevent overloading.

In some implementations, payload capacity data and location data is received for a transport vehicle. A computer system can use a GPS module and wireless communication to determine real-time locations of a cold planer and support machines sending the payload data. Remaining payload capacity for the transport vehicle is determined by analyzing payload capacity data along with real-time payload measurements received from the cold planer's conveyor-based measurement system. The computer system can continuously update capacity calculations as material is loaded using wireless data exchange. A loading sequence is produced by analyzing GPS location data for the transport vehicle and machines while incorporating remaining payload capacity calculations. Machine identities and optimal loading order between the cold planer and support machines are established based on their relative positions and material transfer capabilities. The loading sequence specifies coordinated target payload amounts for each machine to efficiently utilize remaining capacity while preventing overloading.

### BRIEF DESCRIPTION OF THE DRAWINGS.

FIG. 1 is a drawing that illustrates an environment including multiple example machines during a material loading operation, in accordance with some aspects of the present technology.

FIG. 2 is a drawing that illustrates an example multi-machine payload system for real-time total load monitoring, in accordance with some aspects of the present technology.

FIG. 3 is a flowchart that illustrates an example process for payload monitoring in real-time, in accordance with some aspects of the present technology.

FIG. 4 is a flowchart that illustrates an example process for determining a total accumulated weight for a transport vehicle in real-time, in accordance with some aspects of the present technology.

FIG. 5 is a flowchart that illustrates an example process for integrating payload measurements from cold planers and support machines, in accordance with some aspects of the present technology.

FIG. 6 is a block diagram that illustrates an example of a computer system in which at least some operations described herein can be implemented.

### DETAILED DESCRIPTION

This document discloses methods, systems, and apparatuses for implementing a multi-machine payload system that integrates payload measurements from cold planers and/or support machines such as wheel loaders to deliver accurate real-time total payload estimates when loading trucks. The systems combine payload data from cold planers using conveyor-based measurement systems with data from support machines using various identification methods including global positioning system (GPS) location tracking, wireless communication, and/or proximity detection to determine machine-truck associations. The disclosed methods determine machine identities using manual operator input, GPS data, or proximity detection, then combine the payload information to calculate total accumulated weight in real-time. The systems compare the weight against predetermined weight limits and generates alerts when approaching these limits.

The key features include automatic tracking of cumulative payload from multiple loading sources, real-time weight monitoring and alerts, machine-to-machine communication capabilities, support for various machine identification methods, and ability to prevent overloading beyond desired weight limits. The systems can be implemented using individual machine controllers, machine-to-machine communication, or servers, providing flexibility in deployment. The disclosed methods enable operators to optimize truck loading efficiency while ensuring compliance with weight restrictions.

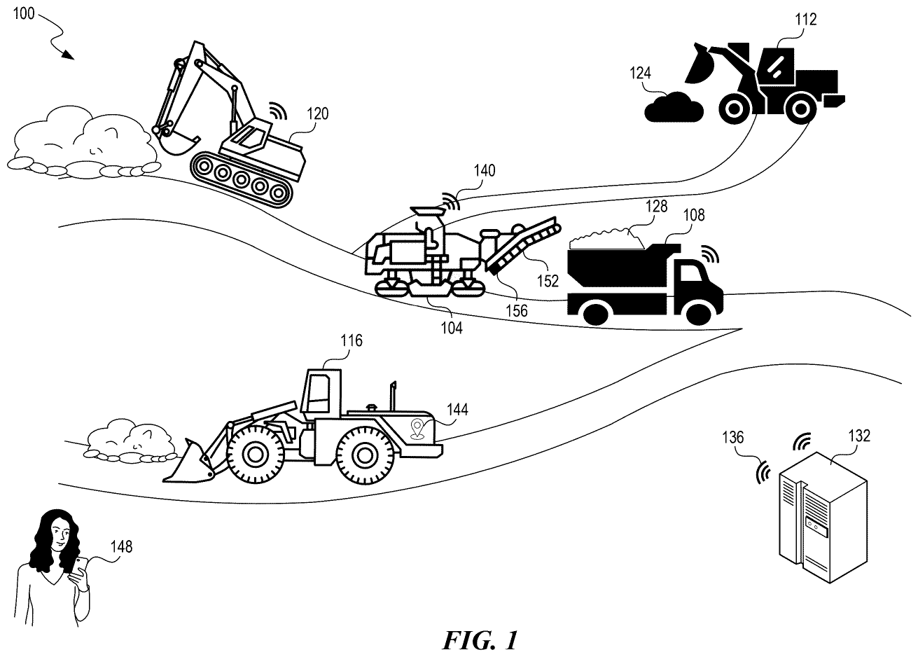

FIG. 1 is a drawing that illustrates an environment 100 including multiple example machines during a material loading operation, in accordance with some aspects of the present technology. The environment 100 includes multiple systems for monitoring payload across construction equipment during material loading operations. The environment 100 implements a multi-machine payload monitoring system that combines real-time payload measurements from both cold planers (e.g., cold planer 104) and support machines (e.g., excavator 120) to provide accurate total payload estimates when loading trucks (e.g., transport vehicle 108).

The cold planer 104 operates within environment 100 to remove layers of asphalt surfaces using a rotating milling drum fitted with cutting tools. The milled material 128 is transferred via a conveyor system including conveyor belt 152 driven by motor 156 for transferring the milled material 128 into a transport vehicle 108. The material 124 can be the same as or different from the material 128. The conveyor system includes force sensors configured to measure material weight on the conveyor belt 152 and speed sensors to measure conveyor belt speed, enabling determination of material flow rates. The cold planer 104 includes a yield measurement system that determines a mass flow rate based on multiple sensor inputs. For example, force transducers attached to roller assemblies measure the downward force of material on conveyor belt 152, while inclinometers determine the angle of inclination to account for gravitational effects. The cold planer 104 also includes pressure transducers that monitor hydraulic pressures upstream and downstream of motor 156 to determine power output and material transfer status.

The wheel loader 112 operates as a support machine alongside cold planer 104. The wheel loader 112 includes a payload measurement system that can determine load weight using boom angle sensors and hydraulic cylinder pressure sensors, enabling precise measurement of bucket loads even when operating on inclined surfaces. The payload measurement system generates bucket weight data in real-time as material 124 is loaded and transferred to transport vehicle 108.

The excavator 120 and skid steer 116 can also operate within environment 100 as additional support machines. Like wheel loader 112, these machines are equipped with payload measurement capabilities that feed into the overall monitoring system using wireless signals 140. Compact track loaders can also operate within environment 100 as additional support machines. A compact track loader is a type of support machine similar to skid steer 116 but operates on continuous rubber tracks instead of wheels. A compact track loader would be equipped with payload measurement systems using boom angle sensors and hydraulic cylinder pressure monitoring to determine bucket loads during material transfer operations. Compact track loaders would integrate into the wireless communication network shown by FIG. 1 to transmit payload data and receive loading sequence instructions from computer server 132, enabling coordinated material handling alongside the cold planer 104.

The environment 100 includes computer server 132 that can implement a scheduling system for coordinating material loading operations. The payload monitoring system and the scheduling system can be implemented as a single system or as different systems. Either the payload monitoring system or the scheduling system can also be implemented on mobile device 148. Each support machine includes sensors to measure bucket angles, hydraulic pressures, and load weights that are transmitted to computer server 132, which can receive information using wireless signals 136.

The scheduling system receives payload data and location data (e.g., from GPS module 144) for support machines and transport vehicles, and determines loading sequences based on machine positions and remaining payload capacities of the transport vehicles. For example, the scheduling system tracks GPS location data to determine relative positions between machines and transport vehicles. In implementations, the scheduling system determines loading sequences that specify machine identities, loading order, and target payload amounts. The scheduling system can determine estimated loading completion times based on mass flow rates from the cold planer 104 and loading rates of material by support machines. The scheduling system can continuously update the sequences in real-time as machines move and payload amounts change, transmitting updates using wireless signals 140.

The scheduling system implements algorithms to coordinate material loading operations across machines 104, 112. For example, Dynamic Priority Scheduling can assign priority levels to machines based on their current payload amounts, proximity to transport vehicle 108, and estimated completion times. Priorities are updated as conditions change using the payload monitoring system implemented on computer server 132. In some examples, Nearest Neighbor Sequencing uses GPS module 144 location data and short-range wireless module proximity detection to improve loading sequences by reducing travel distances between machines 104, 112 and transport vehicle 108 while maintaining payload targets. Predictive Load Balancing can be used to analyze historical mass flow rates from cold planer 104 and bucket weight data from support machines like wheel loader 112 to determine loading sequences and material transfer rates.

Multi-Machine Coordination processing can be used to coordinate reduced material transfer rates across all loading machines when approaching weight limits. Real-Time Dispatch Optimization can be used to determine when to dispatch filled transport vehicles and request empty vehicles based on current loading progress monitored using force sensors and speed sensors. The scheduling system factors in weight limits and remaining capacity data for the transport vehicle transmitted using wireless signals 140 to mobile device 148. Adaptive Sequence Planning can be used to automatically adjust loading sequences based on machine availability tracked using visual identification system 208, payload measurement accuracy levels, and transport vehicle requirements. The scheduling algorithms can determine loading sequences to prevent overloading while improving efficiency, with an operator monitoring progress using electronic displays.

In some implementations, an identification system determines machine-to-truck associations using manual operator input, GPS module 144 tracking, and proximity detection using short-range wireless signals. Short-range wireless signal technology enables direct communication between machines 104, 112, mobile device 148, and the computer server 132 in the environment 100. The scheduling system can use wireless communication between machines, computer server 132, and mobile device 148 to enable real-time sharing of payload data, machine locations, and loading status updates. For example, the scheduling system uses wireless modules to transmit payload data, location information, and status updates between cold planer 104, support machines 112, 116, and transport vehicle 108.

The wireless technology can include Bluetooth, WiFi, and other short-range wireless protocols that enable proximity detection between machines and trucks. The short-range wireless modules establish machine-to-machine connections to share real-time payload measurements, bucket weight data, and loading sequence updates. This wireless communication infrastructure allows rapid data exchange to coordinate loading operations and prevent vehicle overloading. The scheduling system can automatically detect when machines are within communication range to determine machine-truck associations and enable payload data sharing. Multiple wireless protocols may be used simultaneously to ensure reliable data transmission across the worksite while maintaining low latency for critical real-time monitoring functions.

The computer server 132 can implement accuracy determination algorithms that evaluate payload measurement precision based on sensor inputs and operating conditions. For example, the scheduling system applies corresponding accuracy tolerances to payload measurements, adjusting calculations to maintain reliable weight determinations across varying conditions. This accuracy monitoring enables the scheduling system to provide confidence levels for payload measurements and adjust control parameters accordingly. For example, an acceptable range of error within a sensor's measurement can be determined, typically expressed as a plus/minus value around a true value, and can be assessed through calibration, statistical analysis of repeated measurements, and considering factors like environmental conditions and sensor characteristics like non-linearity, hysteresis, and repeatability.

Mobile device 148 displays comprehensive payload information including current fill levels, remaining capacity for the transport vehicle, estimated completion times, and loading sequence details to operators. In some implementations, the scheduling system generates alerts using mobile device 148 when approaching weight limits and can automatically adjust material transfer rates using motor 156 control to optimize loading efficiency while ensuring compliance with weight restrictions. An alert generation module can implement multiple types of alerts to notify operators about payload status and weight limits. Visual alerts displayed using an electronic display include real-time fill level indicators, remaining capacity amounts, and warning messages when approaching predetermined weight limits.

The scheduling system can generate audible warnings using a speaker that can change in pattern or intensity as fill levels increase. Proximity-based alerts notify operators when machines move within range for loading operations, using data from a short-range wireless module and/or a GPS module. The scheduling system can send automated dispatch alerts using mobile device 148 when transport vehicle 108 reaches capacity or when empty vehicles are needed. Weight limit alerts can be transmitted using a communication module to coordinate reduced material transfer rates across all loading machines. These include automatic control signals to adjust conveyor speeds and bucket load targets. The system also generates compliance alerts to prevent exceeding road weight restrictions or fleet operator limits. Alerts transmitted using wireless signals 136 can provide real-time status updates to computer server 132 for tracking multiple transport vehicles and recording fill levels over time.

The payload monitoring system can process information received using a network from various machines and sensors. The information enables tracking of bucket weight data from support machines along with conveyor belt 152 payload measurements from cold planer 104. The payload monitoring system combines these inputs while accounting for measurement accuracies to maintain precise real-time monitoring of total accumulated payload. The cold planer's conveyor system utilizes motor 156 to drive conveyor belt 152 at controlled speeds based on desired material transfer rates. Force sensors attached to roller assemblies measure the downward force of material 128 on conveyor belt 152, while speed sensors monitor belt velocity for mass flow calculations. The system automatically recalibrates measurements when conveyor belt 152 is not transferring material to maintain accuracy throughout operations.

In implementations, the scheduling system maintains a dynamic loading sequence that accounts for machine positions tracked via GPS module 144, current payload amounts, and transport vehicle requirements. For example, the scheduling system determines estimated completion times by analyzing mass flow rates from conveyor belt 152, bucket capacities, and cycle times for each machine. The sequence is continuously updated based on real-time tracking of machine movements and progress toward target payload amounts, with updates transmitted using wireless signals 140. Support machines transmit bucket weight data using wireless signals each time material 124 is loaded, allowing computer server 132 to track individual bucket loads and maintain running totals. Cold planer 104 provides continuous mass flow rate data based on conveyor belt 152 measurements, enabling real-time calculation of material transferred. These inputs are combined with accuracy tolerances to determine total accumulated weight and remaining capacity for the transport vehicle.

The payload monitoring system implements control algorithms on computer server 132 to automatically regulate material transfer rates. When approaching weight limits, conveyor belt 152 speed is reduced using motor 156 control, while support machines receive alerts via wireless signals 136 to adjust loading rates. The coordinated control prevents overloading. The environment 100 enables comprehensive payload monitoring using integration of motor 156, conveyor belt 152, wireless signals 136, 140, GPS module 144, and computer server 132. Mobile device 148 provides operators with real-time visibility into the loading process, while measurement and control systems ensure accurate payload tracking across all machines. This integrated approach allows construction operations to increase loading efficiency while ensuring compliance with weight restrictions using precise monitoring of cumulative payload from all loading sources.

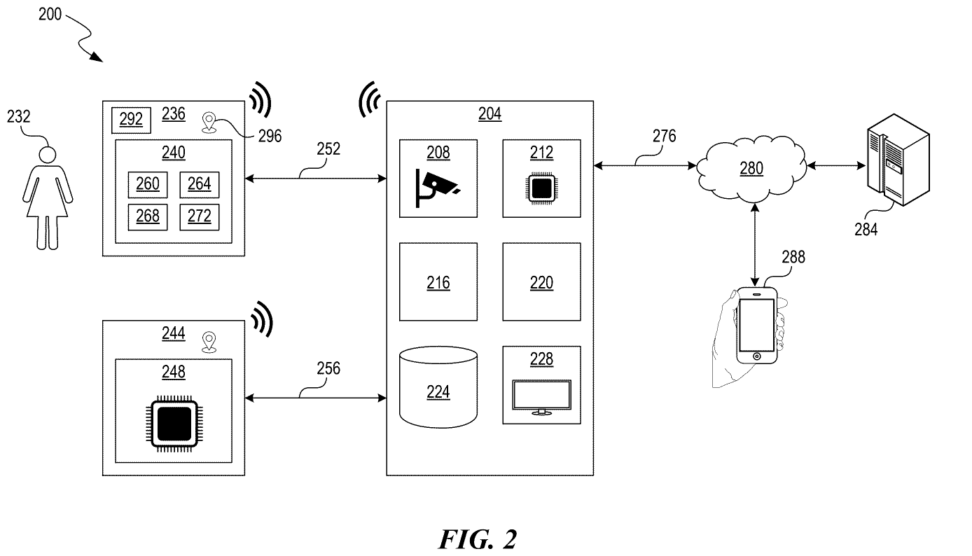

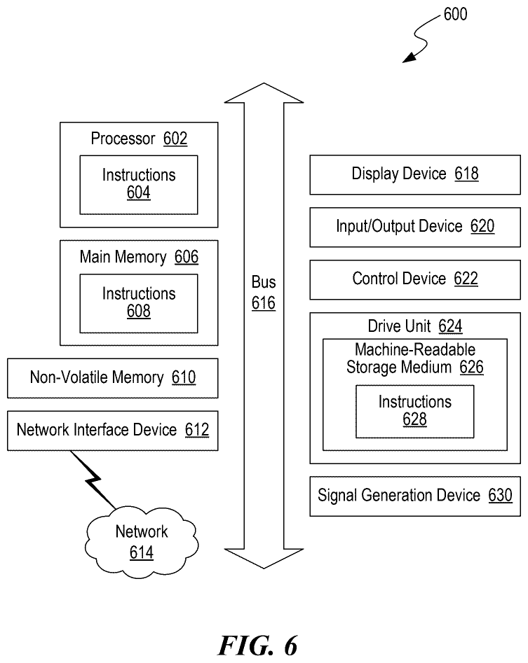

FIG. 2 is a drawing that illustrates an example multi-machine payload system 200 for real-time total load monitoring, in accordance with some aspects of the present technology. The system 200 includes a payload monitoring system 204 that combines real-time payload measurements from both cold planers and support machines to provide accurate total payload estimates when loading transport vehicles. The system 200 is implemented using components of example computer system 600 illustrated and described in more detail with reference to FIG. 6. Likewise, embodiments of example system 200 can include different and/or additional components or can be connected in different ways.

In some implementations, the visual identification system 208 determines machine-to-truck associations using manual operator input and/or computer vision methods. GPS tracking and/or proximity detection between machines and transport vehicles can also be used to determine identity of machines. The system 204 processes the identification data using computer processor 212 to enable accurate tracking of which machines are loading specific transport vehicles. Communication module 216 enables data exchange between machines, operators, and cloud servers using wireless networks. The module 216 transmits payload data, machine locations, and loading status updates in real-time to coordinate loading operations. Alert generation module 220 produces warnings when approaching weight limits and can generate signals or instructions to automatically adjust material transfer rates.

Memory 224 can store critical operational data including tare weights for different transport vehicle types, calibration parameters, and historical loading information. The system 204 displays comprehensive payload information using electronic display 228, allowing an operator to monitor loading progress and receive alerts. The first machine 236 (e.g., a cold planer) incorporates first payload measurement system 240 that determines material transfer rates using force sensors 268 and speed monitoring on conveyor systems. The second machine 244 utilizes second payload measurement system 248 to measure bucket loads using boom angle sensors and hydraulic pressure monitoring.

The system 204 processes first payload data 252 from the cold planer's conveyor-based measurement system along with second payload data 256 from support machine bucket weight measurements. The data is combined to calculate total accumulated weight and determine remaining capacity for transport vehicles. Conveyor belt 260 transfers material from the cold planer while being monitored by multiple sensor systems. Hydraulic motor 264 drives the conveyor belt with its power output and pressure differential measured to help determine material transfer status. Force sensors 268 measure the downward force of material on the conveyor belt while speed sensors 272 monitor belt velocity for mass flow calculations.

The system 204 can send alerts within information 276 using network 280 to the computer server 284 or the mobile device 288. Network 280 can enable data exchange using various communication protocols. Direct data links like Ethernet connections and connected area networks (CAN) can be used for local machine-to-machine communication. For wireless connectivity, the network 280 can use radio, satellite, cellular, Bluetooth, WiFi, infrared communication, and/or other short-range and long-range communication using communication module 216. The network infrastructure allows rapid data exchange to coordinate loading operations while maintaining low latency for critical real-time monitoring functions. Multiple wireless protocols may be used simultaneously to ensure reliable data transmission across the worksite, with computer server 284 processing information received through the network 280 from various machines and sensors.

The system 204 or the computer server 284 can implement scheduling algorithms that coordinate loading sequences based on machine positions, payload amounts, and transport vehicle requirements. Mobile device 288 provides operators with real-time visibility into the loading process using a user interface displaying current fill levels, remaining capacity, and loading sequence details.

The short-range wireless module 292 enables proximity detection between machines and transport vehicles while facilitating direct machine-to-machine communication of payload data. GPS module 296 provides precise location tracking to support loading sequence optimization and machine-to-truck association determination. The payload monitoring system 204 implements accuracy determination algorithms that evaluate measurement precision based on sensor inputs and operating conditions. The system 204 applies corresponding accuracy tolerances to payload measurements from both first payload measurement system 240 and second payload measurement system 248, adjusting calculations to maintain reliable weight determinations.

The computer processor 212 executes scheduling algorithms that maintain dynamic loading sequences accounting for machine positions tracked via GPS module 296, current payload amounts, and transport vehicle requirements. The processor 212 determines estimated completion times by analyzing mass flow rates, bucket capacities, and cycle times for each machine. The alert generation module 220 produces visual and audible warnings using electronic display 228 when approaching weight limits. The module 220 can coordinate with communication module 216 to transmit alerts to mobile device 288 and automatically adjust material transfer rates using hydraulic motor 264 control.

The system 204 enables comprehensive payload monitoring using integration of conveyor belt 260 measurements, bucket weight data, and sophisticated control algorithms. Memory 224 maintains historical loading data while computer server 284 can process real-time sensor inputs to optimize loading efficiency while preventing overloading. The network 280 facilitates data exchange between first machine 236, second machine 244, and computer server 284. The network 280 can transmit first payload data 252 and second payload data 256 to enable real-time monitoring of total accumulated weight across all loading sources.

The short-range wireless module 292 automatically detects when machines are within communication range to enable machine-truck associations. The module 292 can enable exchange of payload data between first payload measurement system 240 and second payload measurement system 248 to coordinate loading operations. In some implementations, the visual identification system 208 processes inputs from operator 232 to maintain accurate tracking of machine-to-truck associations. The system 204 displays this information using electronic display 228 while recording loading sequences and fill levels in memory 224. The communication module 216 implements multiple wireless protocols to ensure reliable data transmission across the worksite. The module 216 can coordinate with alert generation module 220 to deliver warnings and control signals while maintaining low latency for critical real-time monitoring functions.

The computer server 284 and/or system 204 executes load prediction algorithms that analyze historical mass flow rates and bucket weight data to optimize loading sequences. For example, the server 284 adjusts sequences in real-time based on payload measurements while coordinating reduced material transfer rates when approaching weight limits. The integrated system 200 enables construction operations to increase loading efficiency while ensuring compliance with weight restrictions using precise monitoring of cumulative payload from all loading sources. The combination of conveyor belt 260 measurements, bucket weight data, and sophisticated control algorithms provides comprehensive payload monitoring capabilities.

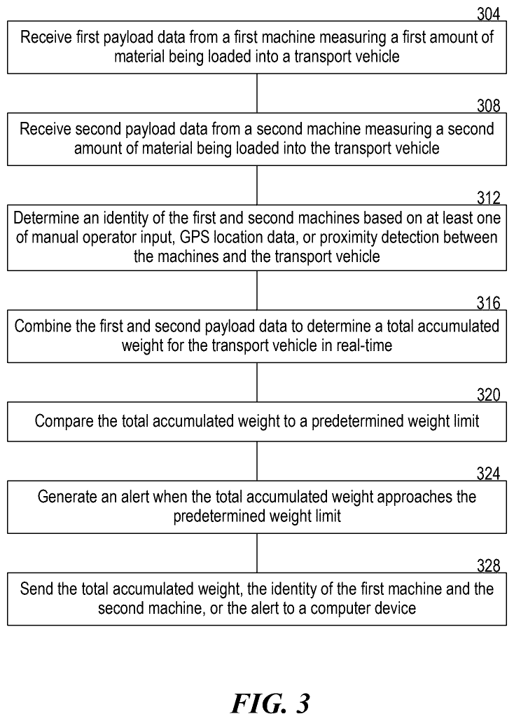

FIG. 3 is a flowchart that illustrates an example process for payload monitoring in real-time, in accordance with some aspects of the present technology. In some implementations, the process is performed by the system 204 illustrated and described in more detail with reference to FIG. 2. A computer system 600 illustrated and described in more detail with reference to FIG. 6 performs some or all of the steps of the process in other implementations. Likewise, implementations can include different and/or additional steps or can perform the steps in different orders.

At 304, a computer system receives first payload data from a first payload measurement system of a first machine. Example payload data 252, an example first payload measurement system 240, and an example first machine 236 are shown by FIG. 2. The first machine can be a cold planer that uses a conveyor-based measurement system incorporating force sensors and speed sensors to monitor material transfer using a conveyor belt. An example cold planer 104 and an example conveyor belt 152 are shown by FIG. 1. The first payload data can be obtained via multiple integrated sensor systems that measure material transfer. For example, force sensors mounted on roller assemblies measure the downward force of material on a conveyor belt, while speed sensors monitor belt velocity to enable mass flow calculations. Example sensors 268, 272 are shown by FIG. 2.

A communication module can receive the payload data using wireless machine-to-machine communication using a short-range wireless module to enable direct data exchange between machines. An example communication module 216 and example short-range wireless module 292 are shown by FIG. 2. The computer system can use cellular network communication and/or server communication using a computer server to transmit payload information across a network. An example computer server 132 is shown by FIG. 1. Wireless signals can enable real-time data transmission while maintaining continuous monitoring of material transfer using integrated communication protocols between the machines and computer devices. An example computer device 148 is shown by FIG. 1. The computer system can automatically recalibrate measurements when the conveyor is not transferring material to maintain accuracy during operations. The first payload data can be sent to a computer processor, which combines conveyor belt measurements with accuracy tolerances. The processor can analyze mass flow rates, conveyor speeds, and force measurements to determine real-time payload amounts being loaded into a transport vehicle.

At 308, the computer system receives second payload load from a second payload measurement system of a second machine. The second machine can be a support machine such as a wheel loader, an excavator, a tractor, an earthmover, a compact track loader or a skid steer that assists in material handling operations. Example support machines 112, 116, 120 are shown by FIG. 1. The support machine has a second payload measurement system, which can determine bucket loads using boom angle sensors and hydraulic cylinder pressure monitoring to enable precise measurement of loaded material. The second payload load can include bucket loads measured using boom angle sensors and hydraulic cylinder pressure monitoring. Weight calculations to account for ground surface inclination angles and pressure differentials across hydraulic cylinders can be performed to enable precise measurement even when operating on slopes. The second payload data is received using a communication module and can be sent to a computer processor, which applies accuracy tolerances and combines bucket weight data with known features of a transport vehicle to determine fill levels and remaining capacity for the transport vehicle.

A memory can store tare weights for different transport vehicle types along with volumetric capacities and weight limits. An example memory 224 is shown by FIG. 2. The computer system can also receive tare weight data using manual operator input via an electronic display or automatically using wireless signals from transport vehicles. The computer system determines remaining capacity by subtracting the total accumulated weight and tare weight from the predetermined weight limit. The computer system can continuously update remaining capacity determinations as additional material is loaded, enabling real-time monitoring of fill levels. The computer system can display remaining capacity using an electronic display while tracking multiple transport vehicles over time. An alert generation module can use the remaining capacity amount to coordinate reduced material transfer rates and generate warnings when approaching capacity limits.

At 312, the computer system determines machine identities (e.g., using visual identification system 208 of FIG. 2). When using manual operator input, an operator can select or enter machine identifications using an electronic display, allowing explicit association between specific machines and transport vehicles being loaded. The computer system can store these manual associations in memory for tracking loading operations. For GPS-based identification, the GPS module 296 (of FIG. 2) can generate signals indicating geographical positions of the first machine, the second machine, and transport vehicles. A computer processor can analyze the location signals using algorithms to determine which machines are positioned near specific transport vehicles. The computer system can continuously track relative positions between machines to maintain accurate loading associations. In some implementations, proximity detection uses the short-range wireless module to automatically detect when machines move within communication range of transport vehicles. The computer system can establish direct wireless connections between nearby machines to enable payload data sharing and loading coordination.

At 316, the computer system combines the first payload data (e.g., from a cold planer's conveyor-based measurement system) with the second payload data (e.g., from a support machine's bucket weight measurements) to determine a total accumulated weight in real-time. For example, mass flow rates from conveyor belt measurements along with individual bucket load data can be used while applying corresponding accuracy tolerances to maintain reliable weight determinations. The computer system can track cumulative material transfer based on data from the conveyor system while combining it with boom angle and hydraulic pressure measurements from bucket loading operations. Total accumulated weight calculations account for conveyor belt mass flow rates, bucket load measurements, and transport vehicle parameters including tare weight and remaining capacity. A memory can maintain historical loading data while the computer system processes real-time sensor inputs using algorithms to determine total accumulated weight across all loading sources. The integrated measurement approach enables monitoring of cumulative payload while automatically compensating for operating conditions using continuous calibration. The computer system can display real-time total accumulated weight on an electronic display while generating alerts using an alert generation module when approaching predetermined weight limits.

At 320, the computer system compares the total accumulated weight against predetermined weight limits stored in a memory to prevent overloading transport vehicles beyond desired capacity restrictions. For example, the computer system retrieves weight limits including road restrictions, fleet operator limits, and manufacturer specifications from stored transport vehicle parameters. The alert generation module 220 of FIG. 2 can continuously monitor the comparison between current total accumulated weight and the predetermined weight limit to enable automated control responses. When the total accumulated weight approaches the weight limit, the computer system coordinates reduced material transfer rates across loading machines while generating visual and audible warnings using an electronic display. In implementations, the computer system tracks remaining capacity for the transport vehicle by comparing the total accumulated weight against both the predetermined weight limit and transport vehicle tare weight. This enables real-time monitoring of fill levels while ensuring compliance with weight restrictions using precise tracking of cumulative payload from all loading sources.

At 324, the computer system produces visual and audible warnings (e.g., via an electronic display) when the total accumulated weight approaches the predetermined weight limit. The computer system can generate escalating alerts by changing sound patterns and light intensities as fill levels increase, providing graduated warnings to operators. A communication module can transmit alerts to a mobile device while automatically adjusting material transfer rates using hydraulic motor control when approaching weight limits. The computer system can coordinate reduced conveyor speeds and bucket load targets across one or more loading machines to prevent exceeding capacity restrictions. The alerts enable operators to improve truck loading efficiency while ensuring compliance with weight restrictions using automated monitoring and control responses. A warning device can provide visual and/or audible notifications that can be detected by machine operators and other personnel to coordinate loading operations. The computer system can automatically track alert history in a memory while maintaining real-time monitoring of remaining capacity using continuous payload measurements.

The computer system can automatically reduce material transfer rates using coordinated control of hydraulic motors and conveyor belt speeds of a cold planer when the total accumulated weight approaches the predetermined weight limit. For example, the computer system monitors mass flow rates from both the cold planer's conveyor system and support machine bucket loads, automatically reducing transfer speeds using hydraulic motor control when fill levels reach specified thresholds.

At 328, the computer system transmits alerts and machine identity information using a network to a computer device to enable real-time monitoring of loading operations. For example, the computer system sends machine identities determined using a visual identification system along with payload alerts using wireless signals to coordinate loading activities. The computer device can process transmitted data including machine identifications (e.g., from a GPS module and/or proximity detections from short-range wireless module). The computer system can maintain records of machine-to-truck associations while delivering alerts using a mobile device when approaching weight limits. The integrated communication approach enables comprehensive tracking of loading operations by transmitting both alert notifications and machine identity information to computer devices. An alert generation module can coordinate with a communication module to deliver warnings while maintaining accurate records of which machines are loading specific transport vehicles.

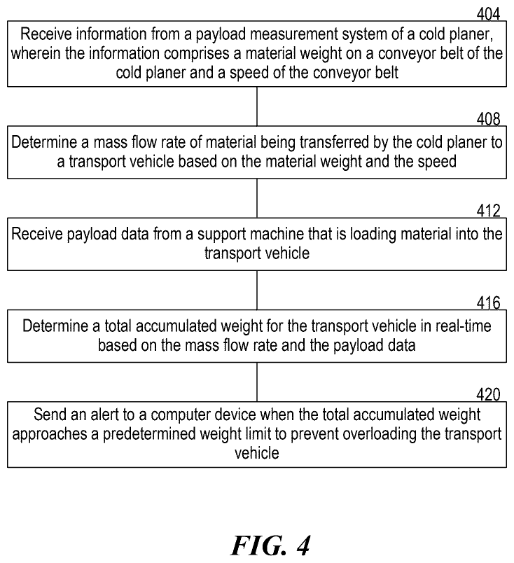

FIG. 4 is a flowchart that illustrates an example process for determining a total accumulated weight for a transport vehicle in real-time, in accordance with some aspects of the present technology. In some implementations, the process is performed by the system 204 illustrated and described in more detail with reference to FIG. 2. A computer system 600 illustrated and described in more detail with reference to FIG. 6 performs some or all of the steps of the process in other implementations. Likewise, implementations can include different and/or additional steps or can perform the steps in different orders.

At 404, a computer system receives information regarding material weight and conveyor belt speed from a cold planer's payload measurement system. The computer system can monitor material transfer using the conveyor belt by processing force sensor data indicating weight of material on the belt along with speed sensor data measuring linear belt velocity.

At 408, the computer system determines a mass flow rate, e.g., by processing force sensor data indicating material weight on a conveyor belt together with speed sensor measurements of belt velocity. The computer system can determine real-time mass flow rates by multiplying the sensed material weight by the conveyor belt speed while applying calibration factors to maintain measurement accuracy during material transfer to the transport vehicle.

At 412, the computer system receives payload data from a support machine, e.g., via wireless signals. The payload data describes material being loaded into a transport vehicle. For example, the computer system receives bucket load measurements from a wheel loader, excavator, compact track loader or skid steer via integrated sensors that monitor boom angles and hydraulic pressures to determine material weights during loading operations. The payload data enables real-time tracking of payload contributions from support machines working alongside the cold planer. The computer system can determine accuracy levels of payload measurement systems by calibration and monitoring of sensor data quality, e.g., from force sensors and speed sensors. For example, corresponding accuracy tolerances are applied to account for sensor calibration states, measurement variations, and environmental factors that may affect payload measurements. When determining total accumulated weight, the computer system incorporates these accuracy tolerances into the real-time weight determinations to maintain measurement precision while accounting for known sensor accuracy limitations during material transfer operations.

The computer system can use a visual identification system and/or a GPS module to determine machine identities by tracking locations and proximity between the cold planer and support machines. The computer system can also utilize wireless machine-to-machine communication using wireless signals and a short-range wireless module to establish machine identities and associations during loading operations. The computer system can process location data and wireless communications to automatically identify machines working together while enabling real-time coordination of payload monitoring.

At 416, the computer system determines total accumulated weight in real-time, e.g., by combining mass flow rate calculations from the cold planer's conveyor system with payload data received from the support machine's measurement system. The computer system can continuously update the total weight by integrating the conveyor-based mass flow measurements with bucket load data while maintaining real-time monitoring of cumulative material transfer to the transport vehicle. The computer system can track and record data for multiple transport vehicles, maintaining records of each vehicle filled during material loading operations. For example, the computer system stores fill level data for each transport vehicle in a memory, including total accumulated weights, remaining capacities, and loading completion times to monitor extended operational periods.

At 420, the computer system sends alerts, e.g., via a communication module to a computer device when the computer system determines the total accumulated weight is approaching the predetermined weight limit. The computer system can transmit warning notifications using wireless signals to prevent overloading by enabling operators to reduce material transfer rates before exceeding transport vehicle capacity limits. The computer system can generate visual indicators and audible warnings using an electronic display and send alert signals using wireless signals to the transport vehicle. The system provides coordinated alerts using visual displays, warning sounds, and wireless communications to notify operators when approaching weight limits during loading operations. This integrated alert approach enables real-time notification using multiple warning methods to prevent overloading.

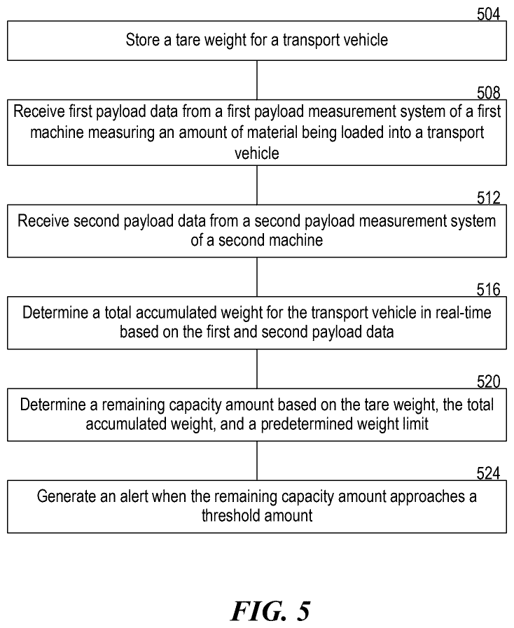

FIG. 5 is a flowchart that illustrates an example process for integrating payload measurements from cold planers and support machines, in accordance with some aspects of the present technology. In some implementations, the process is performed by the system 204 illustrated and described in more detail with reference to FIG. 2. A computer system 600 illustrated and described in more detail with reference to FIG. 6 performs some or all of the steps of the process in other implementations. Likewise, implementations can include different and/or additional steps or can perform the steps in different orders.

At 504, a computer system stores a tare weight for a transport vehicle, which represents the empty weight of the vehicle before loading material. The computer system maintains this stored tare weight value to enable accurate determination of remaining capacity for the transport vehicle and total accumulated weight during loading operations by accounting for the vehicle's base weight. The computer system can receive and store tare weights using manual operator input or automated data exchange when transport vehicles connect to the computer system.

At 508, the computer system receives payload data, e.g., regarding material weight measurements from sensors on a conveyor belt. The computer system can receive real-time weight and speed data using wireless signals to enable continuous monitoring of material being loaded into the transport vehicle. The computer system can process the integrated sensor data to determine material transfer rates while maintaining measurement accuracy during loading operations.

At 512, the computer system receives payload data regarding material weights measured by a second machine's integrated sensors. For example, real-time weight measurements are received to enable continuous tracking of material being loaded. The computer system can determine a loading sequence by analyzing GPS location data for the transport vehicle and machines while incorporating remaining payload capacity calculations. For example, the computer system establishes machine identities and a loading order between the cold planer and support machines based on their relative positions and material transfer capabilities. The loading sequence can specify coordinated target payload amounts for each machine by sending machine-specific loading instructions to maintain synchronized material transfer operations.

At 516, the computer system determines a total accumulated weight in real-time by combining the first payload data with the second payload data from the support machine's integrated measurement systems. The computer system can continuously integrate payload measurements from both machines to maintain accurate real-time monitoring of cumulative material transfer to the transport vehicle to preventing overloading beyond predetermined limits. For example, the computer system determines mass flow rates by analyzing conveyor belt speed data combined with material weight measurements from a cold planer's conveyor system. The computer system determines estimated completion times by dividing the remaining payload capacity by the determined mass flow rate for the cold planer while incorporating loading rate data from support machines.

At 520, the computer system determines a remaining capacity for the transport vehicle by subtracting the sum of the stored tare weight and total accumulated weight from the predetermined weight limit. The remaining capacity determinations are updated in real-time as additional material is loaded. The computer system can update loading sequences by monitoring real-time location changes using GPS modules and wireless signals for the cold planer, support machines, and transport vehicles. The computer system dynamically adjusts machine coordination based on updated position data while incorporating remaining payload capacity calculations to maintain loading efficiency. For example, the system processes bucket weight data in real-time to refine loading sequences by adjusting target payload amounts and machine ordering to account for actual material quantities being transferred.

At 524, the computer system generates an alert when the remaining capacity amount approaches a threshold amount. The computer system can determine predicted load amounts by analyzing real-time sensor data to determine an amount of material currently in transit, e.g., on a conveyor belt. The computer system can incorporate the predicted amounts into the total accumulated weight by combining current conveyor load measurements with already transferred material weights to maintain accurate real-time monitoring.

### INDUSTRIAL APPLICABILITY

The disclosed apparatuses and systems have broad applicability across various construction and infrastructure development scenarios where material loading and transport operations are critical. In road construction and maintenance operations, the disclosed systems enable more precise coordination between cold planers removing existing road surfaces and support machines like wheel loaders and excavators that assist in material handling. These operations often involve multiple trucks being loaded simultaneously while adhering to strict Department of Transportation weight restrictions, making accurate payload monitoring essential. Mining operations represent another key application area where the systems'abilities to track material movement across different types of loading equipment provides significant value. The combination of conveyor-based measurements from primary extraction equipment with bucket-load measurements from support machines enables comprehensive monitoring of material extraction and transport.

Moreover, the disclosed methods find application in large-scale demolition and site preparation projects where various types of material must be removed and transported efficiently. In these scenarios, cold planers may work alongside excavators and wheel loaders to process and load material into multiple transport vehicles. The disclosed systems abilities to track payload contributions from each machine while preventing overloading helps improve the entire material removal process. Infrastructure rehabilitation projects, such as airport runway renovations or large parking facility updates, can benefit from the systems'coordination capabilities. These projects often require precise timing and efficient material handling due to strict operational windows and space constraints.

The benefits and advantages of the implementations described herein include accurate tracking of cumulative payload from multiple loading sources while preventing transport vehicle overloading beyond weight limits. By combining real-time payload measurements from both cold planers and support machines, the disclosed systems provide precise total payload estimates and prevent overloading that could result in fines due to road weight restrictions using real-time monitoring and alerts. The disclosed methods deliver enhanced operational efficiency by enabling operators to improve truck loading efficiency while ensuring compliance with weight restrictions. In some cases, compared to conventional practices of under-loading due to uncertainty, the disclosed methods enable loading trucks to approximately 20% more capacity. This reduces the number of trucks needed to transport material and improves milling efficiency using better coordination between machines.

Moreover, real-time monitoring and control capabilities are achieved using continuous total accumulated weight monitoring across multiple machines. The disclosed systems generate automatic alerts when approaching weight limits and enable automatic reduction of material transfer rates when nearing capacity. This enables operators to track remaining capacity and optimize loading sequences for maximum efficiency. The disclosed methods offers flexible implementation options using individual machine controllers, machine-to-machine communication, or servers.

FIG. 6 is a block diagram that illustrates an example of a computer system 600 in which at least some operations described herein can be implemented. Components of the computer system 600 can be used to implement the systems 204, 240, and 248 shown by FIG. 2.

As shown, the computer system 600 can include: one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 620 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 600. In some implementation, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 612 enables the computer system 600 to mediate data in a network 614 with an entity that is external to the computer system 600 using any communication protocol supported by the computer system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computer system 600. The machine-readable medium 626 can be non-transitory or include a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically include one or more instructions (e.g., instructions 604, 608, 628) set at various times in various memory and storage devices in computing device(s). When read and executed by the processor 602, the instruction(s) cause the computer system 600 to perform operations to execute elements involving the various aspects of the disclosure.

1. A computer-implemented payload monitoring system comprising:
at least one hardware processor; and
at least one non-transitory memory storing instructions, which, when executed by the at least one hardware processor, cause the computer-implemented payload monitoring system:
receive first payload data from a first payload measurement system of a first machine measuring a first amount of material being loaded into a transport vehicle;
receive second payload data from a second payload measurement system of a second machine measuring a second amount of material being loaded into the transport vehicle;
determine an identity of the first and second machines based on at least one of manual operator input, Global Positioning System (GPS) data, or proximity detection between the machines and the transport vehicle;
determine a total accumulated weight for the transport vehicle in real-time based on the first and second payload data;
compare the total accumulated weight to a predetermined weight limit;
generate an alert when the total accumulated weight approaches the predetermined weight limit; and
send at least one of the alert or the identity of the first machine and the second machine to a computer device.

2. The computer-implemented payload monitoring system of claim 1, wherein the first machine comprises a cold planer and the second machine comprises at least one of a wheel loader, an excavator, an earthmover, a tractor, a compact track loader or a skid steer.

3. The computer-implemented payload monitoring system of claim 1, wherein the first payload measurement system comprises:
a conveyor belt;
a hydraulic motor configured to drive the conveyor belt;
force sensors configured to measure material weight on the conveyor belt; and
speed sensors configured to measure conveyor belt speed.

4. The computer-implemented payload monitoring system of claim 1, wherein the at least one hardware processor is configured to:
store a tare weight for the transport vehicle; and
determine a remaining capacity amount based on the tare weight, the total accumulated weight, and the predetermined weight limit.

5. The computer-implemented payload monitoring system of claim 1, wherein the at least one hardware processor is configured to automatically reduce material transfer rates when the total accumulated weight approaches the predetermined weight limit.

6. The computer-implemented payload monitoring system of claim 1, wherein at least one of the first or second payload data is received using at least one of wireless machine-to-machine communication, cellular network communication, or server communication.

7. The computer-implemented payload monitoring system of claim 1, wherein the predetermined weight limit is based on at least one of a road weight restriction or a transport vehicle specification.

8. A computer-implemented method for monitoring payload across multiple machines, comprising:
receiving information from a payload measurement system of a cold planer,
wherein the information comprises a material weight on a conveyor belt of the cold planer and a speed of the conveyor belt;
determining a mass flow rate of material being transferred by the cold planer to a transport vehicle based on the material weight and the speed;
receiving payload data from a support machine that is loading material into the transport vehicle;
determining a total accumulated weight for the transport vehicle in real-time based on the mass flow rate and the payload data; and
sending an alert to a computer device when the total accumulated weight approaches a predetermined weight limit to prevent overloading the transport vehicle.

9. The computer-implemented method of claim 8, comprising determining an identity of the cold planer and the support machine using at least one of a visual identification system, wireless machine-to-machine communication, cellular network communication, Global Positioning System (GPS) data, or short range wireless communication.

10. The computer-implemented method of claim 8, wherein the alert comprises at least one of a visual indicator, an audible warning, or a signal transmitted to the transport vehicle.

11. The computer-implemented method of claim 8, comprising:
tracking multiple transport vehicles filled over a period of time; and
recording fill levels for each transport vehicle.

12. The computer-implemented method of claim 8, comprising:
storing a tare weight for the transport vehicle;
determining a remaining capacity amount based on the tare weight, the total accumulated weight, and the predetermined weight limit.

13. The computer-implemented method of claim 8, comprising:
determining an accuracy level of the payload measurement system;
applying a corresponding accuracy tolerance to the information from the payload measurement system based on the accuracy level, wherein the total accumulated weight is determined using the accuracy tolerance.

14. The computer-implemented method of claim 8, comprising:
automatically reducing material transfer rates when the total accumulated weight approaches the predetermined weight limit.

15. At least one non-transitory computer-readable storage medium storing instructions, which, when executed by at least one data processor of a computer system, cause the computer system to:
store a tare weight for a transport vehicle;
receive first payload data from a first payload measurement system of a first machine measuring an amount of material being loaded into the transport vehicle;
receive second payload data from a second payload measurement system of a second machine;
determine a total accumulated weight for the transport vehicle in real-time based on the first and second payload data;
determine a remaining capacity amount based on the tare weight, the total accumulated weight, and a predetermined weight limit;
generate an alert when the remaining capacity amount approaches a threshold amount.

16. The non-transitory computer-readable storage medium of claim 15, wherein the first machine is a cold planer,
wherein the first payload data comprises material weight on a conveyor belt of the cold planer and a speed of the conveyor belt, and
wherein the instructions cause the computer system to:
determine a mass flow rate of material being transferred by the cold planer to the transport vehicle based on the material weight and the speed of the conveyor belt.

17. The non-transitory computer-readable storage medium of claim 15, wherein the instructions cause the computer system to automatically reduce material transfer rates when the total accumulated weight approaches the predetermined weight limit.

18. The non-transitory computer-readable storage medium of claim 15, wherein at least one of the first or second payload data is received using at least one of wireless machine-to-machine communication, cellular network communication, or server communication.

19. The non-transitory computer-readable storage medium of claim 15, wherein the predetermined weight limit is based on at least one of a road weight restriction or a transport vehicle specification.

20. The non-transitory computer-readable storage medium of claim 15, wherein the instructions cause the computer system to:
determine a predicted load amount currently being transferred to the transport vehicle; and
include the predicted load amount in the total accumulated weight determination.

21-27. (canceled)
